(19) United States
(12) Patent Application Publication
(10) Pub. No.: US 2024/0268558 A1
(43) Pub. Date: Aug. 15, 2024

(54) PADDING FOR SUPPORT DEVICES

(71) Applicant: TARTA DESIGN S.R.L., Cividale Del Friuli (IT)

(72) Inventor: Marco GALANTE, Cividale Del Friuli (IT)

(73) Assignee: TARTA DESIGN S.R.L., Cividale Del Friuli (IT)

(21) Appl. No.: 18/570,432

(22) PCT Filed: Jun. 15, 2022
(86) PCT No.: PCT/IT2022/050173

§ 371 Date: Dec. 14, 2023

(30) Foreign Application Priority Data
Jun. 15, 2021 (IT) 102021000015518

(51) Int. Cl. A47C 7/14; A47C 27/08; A47C 27/10

(52) U.S. Cl. CPC A47C 7/142; A47C 27/10; A47C 27/082

(57) ABSTRACT

Padding (10) for support devices suitable for providing support to a person in a sitting or lying position, comprising a body (12) made of non-deformable and compressible material, having a plurality of seatings (18) and filling elements (20, 26) removably arranged in the seatings (18) and having the function of correcting the posture of a user.

### FIELD OF APPLICATION

The present invention relates to a padding for support devices, such as a seat, a backrest, a sofa, a cushion, a mattress, or more generally any device intended to offer support to a subject in a sitting or lying position. The present padding is advantageously, although not exclusively, usable by a subject with motor disability or postural imbalance.

### BACKGROUND ART

It is known in the art to provide support devices, in particular seats and beds, with a padding of more or less soft material, typically within an inflatable casing with covering functions, the consistency or compressive strength of which offers a convenient support to the body of a user, thereby improving comfort.

The padding can also be designed to provide a distributed consistency either evenly or differentially according to the areas of the body to be supported.

It is known that some subjects, for example those with disabilities, may be forced to assume limited positions or even a single position.

The posture of these subjects is therefore decompensated, often not voluntarily modifiable, and produces postural imbalances. Consequently, even merely maintaining a sitting position on a padding can be difficult, as it cannot compensate for the subject's postural imbalance.

In fact, on the padding known in the art, subjects with motor disabilities, or with postural imbalances, are unable to distribute their body weight correctly. As a result, the subject's weight only burdens specific areas of the body that are in continuous contact with the support device, causing discomfort to the subject and, in severe cases, leading to the occurrence of painful pressure ulcers in these areas.

In addition, the subject may have to make considerable effort, often beyond his or her abilities, to find and maintain balance or to seek a more comfortable position, e.g. a more upright one or, in general, one that provides relief by offloading weight from the areas of the body in contact with the support device.

One drawback of the padding known in the art is that they is unable to adapt to a subject's posture, in particular to compensate for unbalanced postures of subjects with motor problems or postural imbalances.

There is therefore a need to perfect a padding that can overcome one or more of the drawbacks of the prior art.

In particular, one object of the present invention is to provide padding to compensate for a subject's posture imbalances.

A further object of this invention is to provide a padding with compressive strength characteristics that can be quickly and easily customised to the needs of each user.

Another object of the present invention is to provide a padding that is easy to make, inexpensive and simple to use.

A further object of the present invention is to provide a padding that allows air recirculation.

In order to overcome the drawbacks of the known technique and to achieve this and further purposes and advantages, the Applicant has studied, tested and realised the present invention.

### DISCLOSURE OF THE INVENTION

The present invention is expressed and characterised in the independent claims. The dependent claims show other features of the present invention or variants of the main solution proposed.

In accordance with the aforementioned purposes, a padding according to the present invention for support devices suitable for providing support to a subject in a seated or lying position comprises a body made of non-deformable and compressible material, provided with a plurality of seatings extending internally and transversely thereto along a transverse axis, and filling means configured to be compressible and removably arranged within at least one of said seatings.

The padding can be placed inside an inflatable covering, for example a liner, and one or more layers of material can be sandwiched between them, for example, to promote breathability and air circulation, including through the padding itself.

In accordance with one aspect of the present invention, the aforementioned filling means have a different compressive strength than that of the aforementioned body, so that the aforementioned padding has at least two zones with different compressive strengths.

In accordance with another aspect of the present invention, said seatings are arranged parallel from a first end, e.g. rear, to a second end, e.g. front, of said body along a longitudinal axis perpendicular to said transverse axis.

In accordance with a further aspect of the present invention, a plurality of said filling means are insertable in each of said seatings aligned with each other along a longitudinal development thereof.

Thus, by intervening both on the number and position of the aforementioned filling means and on the selection of their compressive strength, it is possible to endow the padding with a compressive strength purposefully adapted and customised to the needs of its user, i.e. to his or her posture, for each individual area, zone or band of the padding.

In particular, the padding of the present invention makes it possible to select, in a desired, variable and freely selectable manner, the compressive strength both in the anterior-posterior direction and from side to side to adapt to the specific needs of the user.

In this way, once the padding has been customised to the subject's posture, the latter will be facilitated by the better distribution of his or her weight, reducing, or even eliminating, the drawbacks of padding of the prior art.

Furthermore, since they are removable, the filling means can be replaced with others of different compressive strength, meaning that some can be removed and others added in different zones or areas, in order to adapt the padding to a subject's postural conditions that may arise, for example, during a posture improvement programme.

In accordance with a further aspect of the present invention, each of said seatings has a substantially circular cross-section and a diameter substantially comprised in a thickness of said body.

The circular shaping allows for easier creation of seatings and filling means as well as an even distribution of compressive strength.

In accordance with another aspect of the present invention, the filling means comprise an inflatable casing configured to be selectively filled with a fluid.

Advantageously, the inflatable casing allows said means to change their compressive strength by varying the volume of fluid therein without the need to remove them from the body of the padding. This allows the padding to be easily adapted even if the conditions of use are highly variable.

In accordance with a further aspect of the present finding, the filling means are of a thickness, or diameter, that is essentially coordinated with the diameter of the seating.

In this way, when the filling means are inserted into the corresponding seat, a substantial contact will occur between the outer circumferential surface of the filling means and the inner circumferential surface of the seating, which allows for a better distribution of compressive strength along the thickness of the padding.

In accordance with a further aspect of the present invention, each seating is provided with an access that extends along the aforementioned transverse axis and that can be selectively opened to allow the corresponding seating to be filled with the filling means.

This means that the filling means can be inserted easily even when the diameter of the seating and the diameter of the filling means are similar and the friction between them would prevent insertion by sliding.

The insertion and removal of filling means is therefore straightforward and requires neither tools nor suitable personnel.

In accordance with a further aspect of the present invention, the aforesaid access defines two fins formed from the aforesaid body and configured to conform both in a position of use, wherein one is at least partially overlapping the other to close the aforesaid access, and also in a filling position, wherein they are selectively separated to open the aforesaid access.

Advantageously, in the position of use, the filling means are thus firmly embedded in the corresponding seating and held in place.

In accordance with a further aspect of the present invention, the aforesaid body is provided with a plurality of holes passing through its thickness and bored between one seating and the other.

In this manner, an exchange of air is achieved between the two surfaces in a way that improves thermal regulation and the reduction of humidity inside the padding itself.

The present invention further relates to a process for making a padding for support devices suitable for providing support to a subject in a seated or lying position comprising a body made of non-deformable and compressible material, wherein the process comprises the fabrication in said body of a plurality of seatings developing internally and transversely thereto along a transverse axis, and providing compressible filling means configured to be insertable in at least one of said seatings.

The procedure also provides for the creation of an access for each of the aforementioned seatings along the aforementioned transversal axis.

### ILLUSTRATION OF THE DRAWINGS

These and other aspects, features and advantages of the present invention will become clear from the disclosure of several embodiments, provided merely by way of example only, with reference to the appended drawings, wherein:

FIG. 1 is an axonometric view of a padding, in a position of use, in accordance with a first embodiment of the present invention;

FIG. 2 shows a side view of the padding of FIG. 1;

FIG. 3 is a detail of FIG. 2 in an enlarged scale;

FIGS. 4a-4d are schematic plan views of possible configurations of use of the padding of FIG. 1;

FIG. 5 is a side view of a padding of FIG. 1 in a filling position.

FIG. 6 is a schematic top-down and partially sectioned view of a padding in accordance with a second embodiment of the present invention.

It should be noted that, in this disclosure, the phraseology and terminology used, as well as the Figures in the attached drawings, even as disclosed, have the sole purpose of illustrating and explaining the present invention, since their function is illustrative and not limited to the invention itself, the scope of protection thereof being defined by the claims.

To facilitate understanding, the same reference numbers have been used, where possible, to denote identical common elements in the Figures. It should be noted that elements and features of an embodiment can be conveniently combined or incorporated into other embodiments without further clarification.

### DISCLOSURE OF SEVERAL EMBODIMENTS

With reference to FIG. 1, a padding 10 for support devices according to the present invention comprises a body 12 made in a single block of compressible and non-deformable material, preferably breathable and provided with a certain consistency or compressive strength.

The body 12 is made of cross-linked foam, such as polyurethane, with a high density that forms an open cell structure ensuring the dissipation of moisture and a high resistance to deformation.

In the example provided, the padding 10 is shaped to pad a seat cushion, for example of a size compatible for a wheelchair seat. However, it should be understood that the invention is not limited to this.

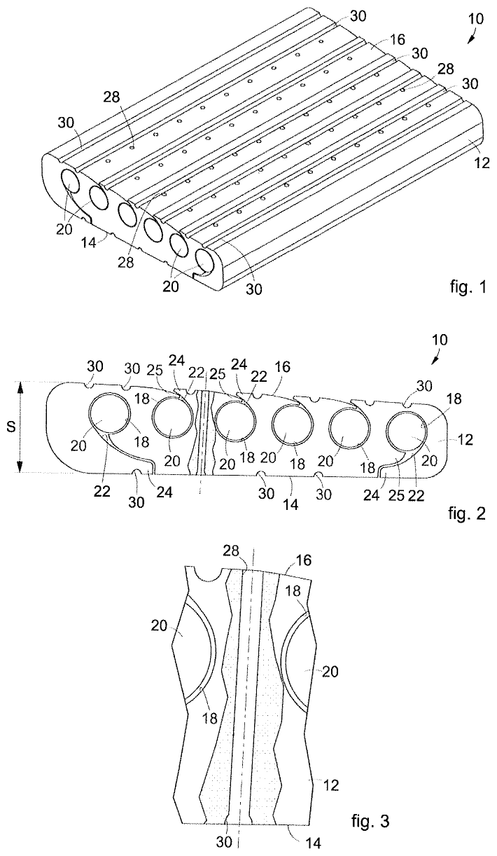

The body 12 comprises both a lower surface, or base 14 (FIG. 2), which in use is facing downwards, i.e. in contact with a support device, and an opposing upper surface, or support surface 16, which in use is facing upwards to come into contact with a user.

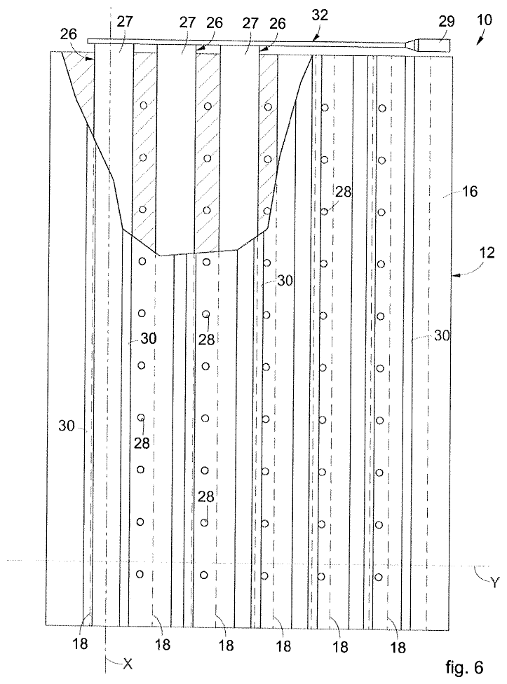

The lower surface 14 and the upper surface 16 are separated by a distance defining a thickness S (FIG. 2) of the body 12, which in the example disclosed herein gradually decreases from the rear towards the front, i.e. along a longitudinal axis Y (FIG. 6).

The thickness S can be between about 30 mm and 120 mm.

In other embodiments, not shown here, the thickness S of the body 12 can also be variable along a transverse axis X.

The body 12 is provided with one or more seatings 18 (FIG. 2) (six in the example provided) of the pass-through type, of substantially cylindrical cross-section, which develop transversely and internally to it along the transverse axis X.

The seatings 18 are arranged parallel from a rear to a front of the body 12 along the longitudinal axis Y perpendicular to the transverse axis X.

The padding 10 also comprises six first filling elements 20 substantially conjugated in shape to the seatings 18 and each inserted selectively removable in one of them. Each first filling element 20 is made of a compressible material, for example foam, provided with a predetermined density that confers a predetermined compressive strength.

Advantageously, the compressive strength of at least one first filling element 20 is different from the compressive strength of the body 12, so that the padding 10 is selectively provided with one or more zones of different compressive strength at least along the longitudinal axis Y.

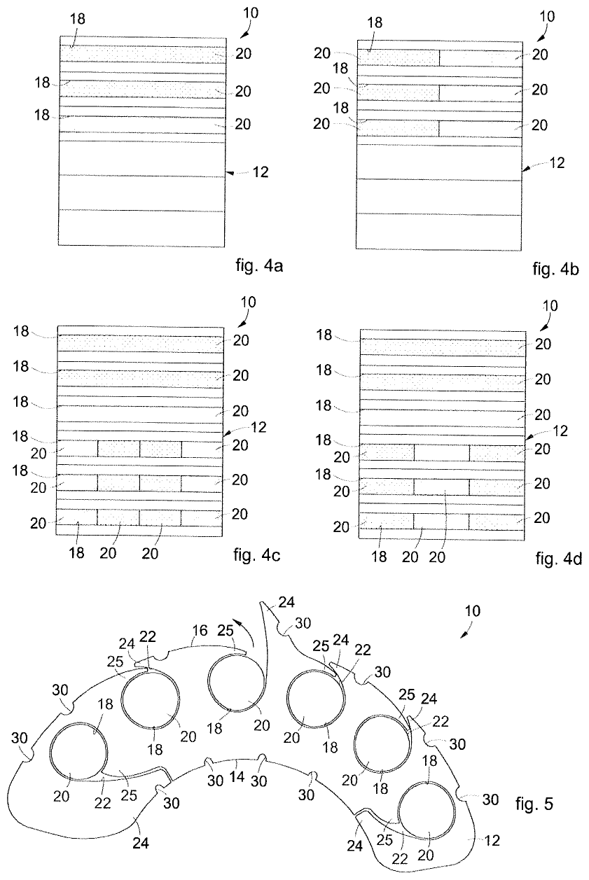

In some embodiments, in a single seating 18 it is possible to insert several first filling elements 20 each aligned with the other along a longitudinal development thereof so as to supply the padding 10 of at least two different compressive strength zones along the transverse axis X (FIG. 4).

The length of each first filling element 20 can be adapted to the length of the seating 18. Naturally, in the event that more than one of them are inserted in the same seating 18, their length can be adapted appropriately and according to the distribution of the compressive strength that is to be obtained along the transverse axis X of the single seating 18.

In a second embodiment, the padding 10 can further include one or more second filling elements 26, in the specific case three (FIG. 6), substantially conjugated in shape to the seatings 18 and each inserted selectively removable in one of them. In the case shown in FIG. 6, the filling elements 26 replace the first filling elements 20 in the filling of three seatings 18.

Each second filling element 26 comprises an inflatable casing 27 configured to be selectively filled with a fluid, e.g. atmospheric air, to generate a desired compressive strength.

The inflatable casings 27 are associated with each other by means of an inflation circuit 32 provided with fluid connection means 29 to be associated with inflation means, not shown here, for example, an air compressor to introduce air into the casings 27.

In the specific case, the inflatable casings 27 are connected to each other by the inflation circuit 32 and arranged at a distance that allows them to be inserted into three adjacent seatings 18.

The fluid connection means 29 are also suitable for allowing the at least partial emptying of each inflatable casing 27 so as to control its compressive strength.

In one variant, each inflatable casing 27 is provided with its own independent fluid circuit, not shown here.

In other embodiments, each inflatable casing 27 may be provided with its own valve, not shown here, which allows fluid passage to be controlled independently of the other inflatable casings 27 connected to the inflation circuit 32.

In one variant, the inflatable casing 27 may internally contain an expansion element, possibly removable, made of compressible material, the structure of which is cross-linked, i.e. provided with pores or cells, and, furthermore, equipped with shape memory.

The expansion element, which for example can be made of a spongy material or cross-linked foam, such as polyurethane, is suitable for assuming either an expanded or resting form wherein the pores or cells are completely accessible to the fluid, or a compressed, or working, form, wherein, depending on a pressure exerted on it, a certain number of pores or cells are compressed and made inaccessible. In the expanded form, the fluid holding capacity of the expansion element is maximised, while in the compressed form this capacity is reduced and the amount of fluid in the compressed pores or cells is expelled outside of the expansion element structure. When, from an at least partially compressed form, the pressure exerted on the expansion element decreases, a certain amount of fluid, depending on the number of pores or cells that become accessible again, is drawn from the outside into the interior of these latter pores or cells, causing a correlated expansion of the expansion element until the expanded form is reached at the moment when the exerted pressure ceases.

The size and shape of the expansion element can be appropriately chosen depending on the size and/or shape of the inflatable casing 27. For example, the expansion element is of a shape related to the inflatable casing 27, meaning that it may preferably be substantially cylindrical in shape and of such dimensions that its outer surface contacts the inner surface of the inflatable casing 27.

In this way, the volume of the expansion element can essentially correlate with the volume of the inflatable casing 27.

When the exchange of fluid between the inflatable casing 27 and the exterior is permitted, for example by suitably operating the fluid connection means 29, or other suitable means which may be provided, and at the same time an external pressure is provided, for example when a user sits on the padding 10 sufficient to bring the expansion element to an at least partially compressed form, then a corresponding amount of fluid present in the expansion element will escape from the inflatable casing 27 which will consequently reduce its volume. When the pressure decreases or ceases, for example when a user rises, at least partially, from the padding 10, fluid is allowed to flow from the outside to the inside of the inflatable casing 27 which consequently increases its volume to a maximum corresponding to the volume of the expansion element in the expanded form.

In this way, it is possible to adjust the amount of fluid within the one or more inflatable casings 27 and consequently their compressive strength without the aid of external inflation means.

In fact, a user of the padding 10 can purposefully adjust the amount of fluid, and hence the compressive strength, inside the one or more inflatable casings 27. This can be done in a desired manner by sitting in the chosen position and allowing the fluid contained therein to flow outwards until the desired compressive strength is achieved. The latter can subsequently be stabilised by interrupting the outward flow of air (e.g. by appropriately operating the fluid connection means 29 or other suitable means, if provided). Otherwise, in order to increase the compressive strength of the one or more inflatable casings 27 from a compressed condition or from an at least partially compressed condition, it will be sufficient for the user to rise from the padding 10, again appropriately operating the fluid connection means 29 or other suitable means that may be provided, as much as necessary to cause a certain amount of fluid to enter from the outside until the desired compressive strength of the one or more inflatable casings 27 is obtained.

In some possible embodiments, the inflatable casing 27 can, along a longitudinal development axis thereof, be internally divided into two or more chambers, not shown here, configured to be inflated/deflated independently to provide, when inserted in the seating 18, a different compressive strength with respect to the transverse axis X.

Optionally, a fluid such as water may also be used to fill the second filling elements 26.

With reference to FIGS. 4a-4d, four different arrangements of the first filling elements 20 are shown within the seatings 18, where the filling elements 20 with high compressive strength are identified with the dark colour while the filling elements 20 with low compressive strength are identified with the light colour.

According to the invention, the arrangements described below, although made with reference to the first filling elements 20, can also be obtained with the second filling elements 26 or with a combination of both.

With reference to FIG. 4a, a padding 10 is shown provided with three seatings 18 obtained in the front of the body 12 and filled according to an arrangement advantageous for sciatic nerve block. In particular, the first and second seatings 18 are filled with two first filling elements 20 with low compressive strength, while the third seating 18 is filled with a first filling element 20 with high compressive strength.

With reference to FIG. 4b, a padding 10 is shown provided with three seatings 18 obtained in the front of the body 12 and filled according to an arrangement advantageous for a condition of pelvic obliquity. In particular, each of the three seatings 18 is filled half with the first filling element 20 with low compressive strength and half with the first filling element 20 with high compressive strength.

With reference to FIG. 4c, a padding 10 is shown provided with six seatings 18 obtained in the body 12 and filled according to an arrangement advantageous for a problem with adduction. In particular, the first and second seatings 18 are filled with a corresponding first filling element 20 with low compressive strength. The third seating 18 is filled with a first filling element 20 with high compressive strength, while the fourth, fifth and sixth seatings 18 are filled, centrally, with a first filling element 20 with low compressive strength and, laterally, with first filling elements 20 with high compressive strength.

With reference to FIG. 4d, a padding 10 is shown provided with six seatings 18 obtained in the body 12 and filled according to an arrangement advantageous for abduction. In particular, the first and second seatings 18 are filled with a first filling element 20 with low compressive strength. The third seating 18 is filled with a first filling element 20 with high compressive strength, while the fourth, fifth and sixth seatings 18 are filled, centrally, with a first filling element 20 with high compressive strength and, laterally, with first filling elements 20 with low compressive strength. Each seating 18 has a diameter C substantially comprised in the thickness S of the body 12.

The ratio between the thickness S and the diameter C is advantageously selected during the construction of the body 12 according to the needs of the user for whom it is intended, as it also makes it possible to change the distribution of the compressive strength.

Each of the first filling elements 20 or each of the second filling elements 26 is of substantially the same thickness, or diameter, as the diameter C of the seating 18, such that their outer circumference surface is in contact with the inner circumference surface of the seating 18 when fitted therein.

Each seating 18 is provided with an access 22 (FIG. 2) that extends along the transverse axis X to allow the seating 18 to be filled with the first filling elements 20 and/or with the second filling elements 26.

In particular, each access 22 is obtained by making a break, or cut, in the lower surface 14 or in the upper surface 16, deep enough to terminate in the seating 18.

In some embodiments, the access 22 defines two fins 24, 25 (FIG. 2) obtained from the body 12 and configured to conform in a use position, wherein one is at least partially overlapping the other to close the access 22, and in a filling position (FIG. 5) wherein they are selectively separated to open the access 22 and thus make the interior of the seating 18 available.

Advantageously, it is possible to separate the fins 24 and 25 of one or more seatings 18, even simultaneously, for example, by bending the body 12 along the transverse axis X.

The body 12 is also provided with a plurality of holes 28 (FIGS. 3 and 6) passing through the thickness S, arranged in a row along the transverse axis X and made between one seating 18 and the other and having the function of promoting air recirculation between the lower surface 14 and the upper surface 16.

The body 12 can further comprise, on the lower surface 14, and on the lower surface 16, a plurality of channels 30 (FIGS. 2 and 3) arranged parallel to one another from a rear part to a front part of the body 12 along the longitudinal axis Y.

This further promotes the passage of air between the lower surface 14 or lower surface 16 and an inflatable cover casing or other possibly interposed layers, for example of the cushion.

In one embodiment, one or more rows of holes 28 may terminate in one of the channels 30 created on the lower surface 14 (FIG. 6).

In some embodiments, the padding 10 can further comprise an active air circulation system, not shown here, for example a fan unit, to force air recirculation inside and/or outside the body 12, for example between the holes 28 and/or the channels 30.

This solution is particularly advantageous for bodies 12 with a high thickness S, for example over 60 mm.

It is clear that modifications and/or additions of parts may be made to the padding 10 disclosed herein, without departing from the scope of the present invention as defined by the claims.

It is also clear that, although the present invention has been disclosed with reference to a few specific examples, a person skilled in the art will undoubtedly be able to realise many other equivalent forms of padding for support devices having the characteristics expressed in the claims and thus all falling within the scope of protection defined herein.

In the following claims, the references in parentheses have the sole purpose of facilitating reading and must not be considered as limiting factors of the scope of protection defined by the claims themselves.

1. Padding (10) for support devices suitable to offer a support to a person in a sitting or lying position, said padding (1) comprising a body (12) made of non-deformable and compressible material, wherein said body (12) is provided with a plurality of seatings (18) which develop internally and transversely to said body (12) along a transverse axis (X), filling means (20, 26), configured to be compressible, being removably disposed inside at least one of said seatings (18).

2. Padding (10) as in claim 1, wherein said filling means (20, 26) have a compressive strength different from a compressive strength of said body (12), so that said padding (10) is provided with at least two zones with a different compressive strength.

3. Padding (10) as in claim 1, wherein said seatings (18) are disposed parallel from a first rear end to a second end of said body (12) along a longitudinal axis (Y) perpendicular to said transverse axis (X).

4. Padding (10) as in claim 1, wherein a plurality of said filling means (20, 26) aligned to each other along their longitudinal development can be inserted in each of said seatings (18).

5. Padding (10) as in claim 1, wherein each of said seatings (18) has a substantially circular cross-section and has a diameter (C) substantially comprised in a thickness (S) of said body (12).

6. Padding (10) as in claim 1, wherein said filling means (26) comprise an inflatable casing (27) configured to be selectively filled with a fluid.

7. Padding (10) as in claim 1, wherein each seating (18) is provided with an access (22) which extends along said transverse axis (X) and which can be selectively opened to allow the filling of the corresponding seating (18) with said filling means (20, 26).

8. Padding (10) as in claim 7, wherein said access (22) defines two fins (24, 25) obtained from said body (12) configured to be conformed both in a position of use, in which one of said two fins (24, 25) is at least partly overlapping with another of said two fins (24, 25) to close said access (22), and also in a filling position, in which said two fins (24, 25) are selectively separated in order to open said access (22).

9. Padding (10) as in claim 1, wherein said body (12) is provided with a plurality of holes (28) made through in the thickness (S), made between one seating (18) and another seating (18).

10. Method to produce a padding (10) for support devices suitable to offer a support to a person in a sitting or lying position, said padding (10) comprises a body (12) made of non-deformable and compressible material, wherein said method it provides to make a plurality of seatings (18) in said body (12), which develop internally and transversely to said body (12) along a transverse axis (X), and to supply compressible filling means (20, 26) and configured so that said compressible filling means (20, 26) can be inserted in at least one of said seatings (18).
